(19) United States
(12) Patent Application Publication
(10) Pub. No.: US 2005/0091821 A1
(43) Pub. Date: May 5, 2005

(54) Method of manufacturing an article having a radio frequency identification (RFID) device

(76) Inventors: Scott D. Best, Troy, MI (US); James F. Turner, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/980,205

(22) Filed: Nov. 3, 2004

Related U.S. Application Data
(60) Provisional application No. 60/516,829, filed on Nov. 3, 2003.

(51) Int. Cl. B23P 11/00; B21D 39/03

(52) U.S. Cl. 29/430; 29/431; 29/791; 29/819

(57) ABSTRACT

A manufacturing machine assembly for producing an article having a radio frequency identification (RFID) device. The article is fabricated from a continuous sheet of stock with an adhesive layer and a release liner. A printing station prints indicia on the sheet of stock. A cutting station cuts the continuous sheet of stock to form first and second strips. The release liner is removed from the first strip to expose the adhesive layer and an applicator applies a number of the RFID devices to the exposed adhesive layer. Coupling rollers, each having an integral notch, bond the adhesive layer of the first strip with the second strip such that the RFID devices are sandwiched between the first and second strips. Alternatively, the release liner from the second strip may also be removed such that the adhesive layer of the first strip is bonded with the adhesive layer of the second strip to sandwich the RFID devices between the adhesive layers.

### CROSS-REFERENCE TO RELATED APPLICATIONS

The subject patent application claims priority to and all the benefits of U.S. Provisional Patent Application Ser. No. 60/516,829, which was filed on Nov. 3, 2003.

### BACKGROUND OF THE INVENTION

1. Field of the Invention

The subject invention relates to a manufacturing machine assembly for producing an article having a radio frequency identification (RFID) device. The subject invention also includes a method for producing such an article.

2. Description of Related Art

Radio frequency identification (RFID) devices are well known in many industries and are utilized for a variety of purposes. In particular, RFID devices have been used in the past for security systems, tracking systems, data collection and management systems, valet communication systems, location systems and the like. The prior art has also contemplated the integration of these RFID devices into cards or multi-layered labels. U.S. Pat. No. 6,520,544 discloses an example of a RFID device integrated into a multi-layered label. The '544 patent, however, as well as the remaining prior art known to the Applicant, fail to disclose an adequate means of incorporating a RFID device into a label or card without potentially damaging the RFID device. Further, these prior art devices fail to disclose an adequate means of retaining the RFID device within the label or card.

Accordingly, it would be desirable to develop a method of manufacturing an article incorporating an RFID device without damaging the RFID device. Further, it would be desirable to develop an article, such as a card or label, that permanently retains the RFID card within the card or label.

### SUMMARY OF THE INVENTION AND ADVANTAGES

The subject invention includes a manufacturing machine assembly for producing an article having a radio frequency identification (RFID) device. The article is fabricated from a continuous sheet of stock having a top surface and a bottom surface with an adhesive layer and release liner. The manufacturing machine assembly includes a support frame for supporting the continuous sheet of stock as the sheet of stock moves through the machine assembly. A printing station prints indicia on the top surface of the continuous sheet of stock that define a first strip and a second strip of the stock. A cutting station is mounted to the support frame for cutting the continuous sheet of stock to separate the first and second strips. A stripping device is mounted to the support frame for removing the release liner from the first strip to expose the adhesive layer. An applicator is mounted to the support frame for applying a plurality of the RFID devices to the exposed adhesive layer of the first strip. A pair of coupling rollers are rotatably mounted to the support frame for moving the adhesive layer of the first strip into a bonded relationship with the second strip to mate the first and second strips and form a continuous series of articles wherein the first strip defines the top surface and the second strip defines the bottom surface of the articles and the plurality of RFID devices are sandwiched between the first and second strips. At least one of the coupling rollers includes an integral notch for providing a passageway for the RFID devices as the first and second strips pass between the coupling rollers, thereby ensuring that the RFID devices are not damaged during the bonding of the first and second strips.

The subject invention also includes an associated method of manufacturing the article having the RFID device. The method comprises the steps of: printing the indicia on the top surface of the continuous sheet of stock to define the first strip and the second strip of the stock; cutting the continuous sheet of stock to separate the first and second strips of stock; removing the release liner from the first strip to expose the adhesive layer; applying a plurality of the RFID devices to the exposed adhesive layer of the first strip; aligning the first and second strips with the coupling rollers; aligning the RFID devices with the notch in the coupling roller; mating the adhesive layer of the first strip with the second strip to bond the first and second strips together and form the continuous series of articles wherein the first strip defines the top surface and the second strip defines the bottom surface of the articles; and simultaneously passing the RFID devices through the notch to ensure that the RFID devices are not damaged as the plurality of RFID devices are sandwiched between the first and second strips.

The subject invention further includes an additional method of manufacturing, including the steps of: printing the indicia on the top surface of the continuous sheet of stock to define the first strip and the second strip of the stock; cutting the continuous sheet of stock to separate the first and second strips of stock; inverting one of the first and second strips 180 degrees relative to the other first and second strip; removing the release liner from the first strip to expose the adhesive layer of the first strip; applying a plurality of the RFID devices to the exposed adhesive layer of the first strip; removing the release liner from the second strip to expose the adhesive layer of the second strip; mating the adhesive layer of the first strip with the adhesive layer of the second strip to bond the first and second strips together and form the continuous series of articles wherein the first strip defines the top surface and the second strip defines the bottom surface of the articles and the plurality of RFID devices are sandwiched between the adhesive layers of the first and second strips.

Accordingly, the subject invention has developed a manufacturing machine assembly, and associated method, that inserts a number of RFID devices within a series of articles, such as a series of labels or cards, without damaging the RFID devices. Further, the subject invention has developed a method of adequately adhering the RFID devices to a series of labels or cards.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of a manufacturing machine assembly in accordance with the subject invention;

FIG. 2 is an exploded cross-sectional view of a sheet of stock taken along line 2-2 of FIG. 1;

FIG. 3 is a fragmentary top view of the sheet of stock taken along line 3 of FIG. 1;

FIG. 4 is a fragmentary perspective view of a cutting wheel;

FIG. 5 is a cross-sectional view taken along line 5-5 of FIG. 1;

FIG. 6 is a fragmentary perspective view of an inverting device, an applicator, and a stripping device;

FIG. 7 is a planar view of a RFID device,

FIG. 8 is a planar view of an alternative RFID device;

FIG. 9 is a fragmentary perspective view of a non-stick roller, a scoring roller, and a pair of coupling rollers;

FIG. 10 is a cross-sectional view of the non-stick roller and a first strip of stock;

FIG. 11 is a cross-sectional view of the coupling rollers and first and second strips of stock;

FIG. 12 is a perspective view of a series of tensioning rollers;

FIG. 13 is a fragmentary perspective view of an exit station;

FIG. 14 is a cross-sectional view of a completely manufactured article after the article exits the manufacturing machine assembly of FIG. 1;

FIG. 15 is a schematic view of an alternative manufacturing machine assembly in accordance with the subject invention;

FIG. 16 is a fragmentary top view of a sheet of stock taken along line 16 of FIG. 15;

FIG. 17 is a cross-sectional view of a completely manufactured article after the article exits the manufacturing machine assembly of FIG. 15;

FIG. 18 is a schematic view of another alternative manufacturing machine assembly in accordance with the subject invention;

FIG. 19 is a fragmentary top view of a sheet of stock taken along line 19 of FIG. 18; and

FIG. 20 is a cross-sectional view of a completely manufactured article after the article exits the manufacturing machine assembly of FIG. 18.

### DETAILED DESCRIPTION OF THE INVENTION

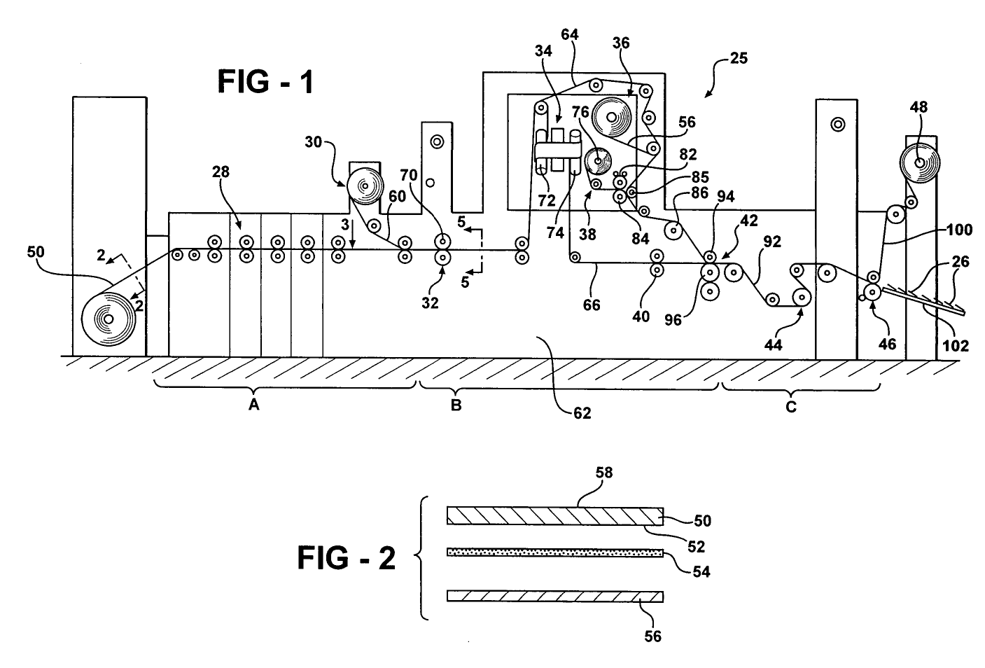

Referring to the Figures, wherein like numerals indicate like or corresponding parts throughout the several views, a manufacturing machine assembly 25 for producing an article 26 having a radio frequency identification (RFID) device 27 in accordance with the subject invention is generally shown in FIG. 1. The manufacturing machine assembly 25 is capable of producing any suitable article 26 or product, such as a promotional mailer, a hang tag assembly, a coupon card, a label of any type, a hanging card, or any other like device of any suitable size. The machine assembly 25 may be divided into three separate sections. Section A includes a printing station 28 and a laminating device 30. Section B includes a cutting device 32, an inverting device 34, a stripping device 36, an applicator 38, a scoring roller 40, and a pair of coupling rollers 42. Section C is an exit station and preferably includes a series of tensioning rollers 44, a pair of exit rollers 46, and a scrap take-up roller 48.

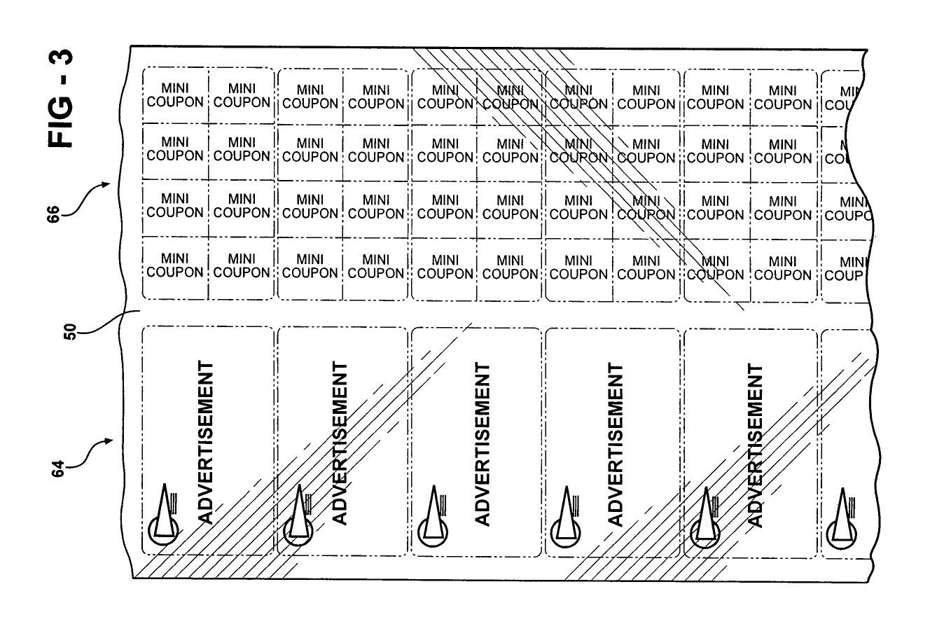

A rolled continuous sheet of stock 50 is mounted to a rotating shaft 76 before the printing station 28 of Section A. This continuous sheet of stock 50, which is also shown in cross-section in FIG. 2, is also known in the art as a web sheet and may be formed of card stock, film, paper stock, or any type of synthetic material. The continuous sheet of stock 50 has a bottom surface 52 with an adhesive layer 54 and a release liner 56 adhered thereto. The sheet of stock 50 also has a top surface 58 which can be covered by clear laminate 60. The clear laminate 60 is discussed in greater detail below. For illustrative purposes in FIG. 2, the relative sizes of the adhesive layer 54 and the release liner 56 are exaggerated. The release liner 56 also includes a silicone finish (not shown) disposed on at least one side, which allows the release liner 56 to be removed from the adhesive layer 54 without removing the adhesive or damaging the sheet of stock 50.

A support frame 62 is provided for supporting the continuous sheet of stock 50 as the sheet of stock 50 moves through the manufacturing machine assembly 25. In particular, the support frame 62 provides a support surface for numerous components of the manufacturing machine assembly 25, including the previously mentioned laminating device 30, cutting device 32, inverting device 34, stripping device 36, applicator 38, scoring roller 40, coupling rollers 42, exit rollers 46 and a scrap take-up roller 48. The support frame 62 may be of any suitable size and shape as is known in the art.

The fabrication of the article 26, for example, a label or card, from the continuous sheet of stock 50 is now discussed in greater detail with reference to FIGS. 1-14. As shown in FIGS. 1 and 3, the continuous sheet of stock 50 is fed into the printing station 28 which prints indicia on the top surface 58 of the continuous sheet of stock 50 to define a first strip 64 and a second strip 66 of the stock. In the embodiment shown in FIG. 3, the indicia is printed in two parallel rows at the same time to define the first 64 and second 66 strips. Commonly printed indicia includes appropriate logos and/or advertisements, and may include manufacturing, marketing, charity information and the like. As shown in FIG. 3, the printed indicia includes marketing information printed on the first strip 64 and a number of mini-coupons printed on the second strip 66. Hence, one contemplated card manufactured by the manufacturing machine assembly 25 includes a number of coupons and can therefore be utilized as a coupon card. As one skilled in the art can appreciate, any type or design of indicia may be printed on either the first 64 or second 66 strips without deviating from the scope of the subject invention. Further, one of the strips 64, 66 may be devoid of printing as is discussed in greater detail below. Finally, the strips 64, 66 may be of any length or width as is desired.

Current printing stations 28 may utilize a number of cyrel printing plates (not shown) as known to those skilled in the art. Variable speed laser printers may also be used as printing stations 28 without deviating from the scope of the subject invention. The length of the printing station 28 is typically dependent upon the number of colors of used, which in turn determines the number of printing plates and/or laser printers used.

The parallel rows defining the first strip 64 and the second strip 66 of the sheet of stock 50 are continuously moving along a path. More specifically, the path is a longitudinal path that generally runs the lengthwise dimension of the manufacturing machine assembly 25. As appreciated, a driving mechanism (not shown) moves the parallel strips of stock 64, 66 along the longitudinal path.

After the printing is complete, the laminating device 30 preferably applies the clear laminate 60 to the top surface 58 of the continuous sheet of stock 50 for protecting and viewing the indicia. Specifically, the laminate 60 is a clear polyester laminate 60 that is rolled onto a shaft (not numbered) above the continuous sheet of stock 50. The laminate 60 protects the top surface 58 of the stock and ensures that the indicia will not smear, rub off, or otherwise be damaged. As is discussed in greater detail below with reference to an alternative embodiment, the application of the clear laminate 60 may be eliminated without deviating from the scope of the subject invention.

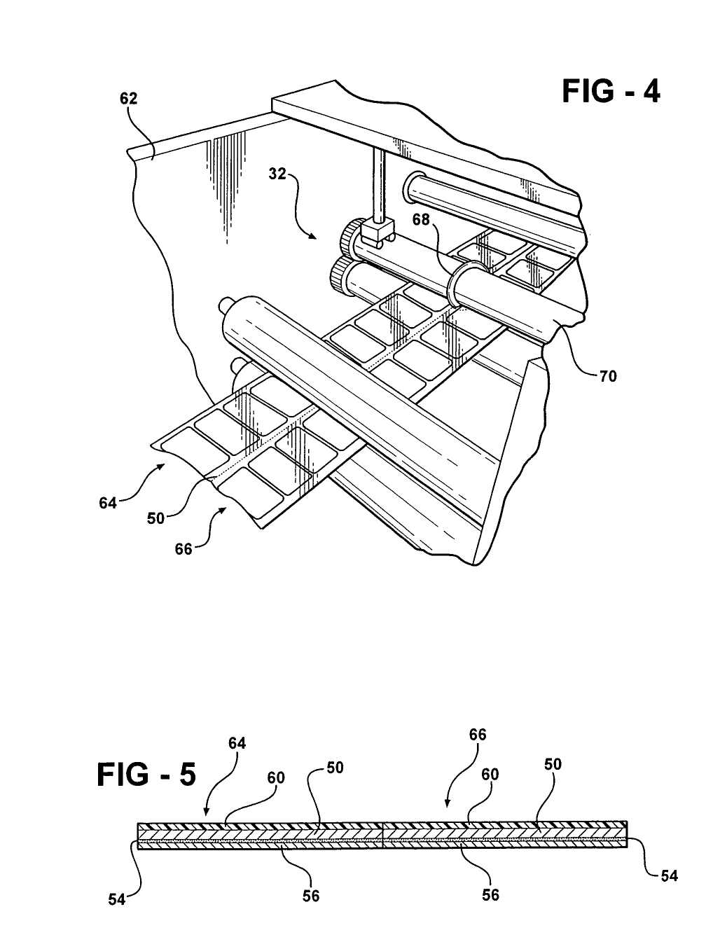

The continuous sheet of stock 50 then moves into Section B, where the cutting device 32 cuts the continuous sheet of stock 50 to separate the first 64 and second 66 strips. As best shown in FIG. 4, the cutting device 32 includes an annular blade 68 anchored to a cutting roller 70. The sheet of stock 50 passes underneath the annular blade 68 wherein the annular blade 68 cuts through the sheet of stock 50 along an unprinted line between the first 64 and second 66 strips. Although the strips 64, 66 are separated, they remain close in proximity to each other. As best shown in FIG. 5, the first 64 and second 66 strips comprise the sheet of stock 50 with the adhesive layer 54 and the release liner 56 applied to the bottom surface 52 and the laminate 60 applied to the top surface 58. The continuous sheet of stock 50 then moves into the inverting device 34 where the first 64 and second 66 strips actually separate. The first strip 64 continues along the longitudinal path and passes over the second strip 66. In other words, the first strip 64 runs the lengthwise dimension of the manufacturing machine assembly 25. The second strip 66 separates from the first strip 64 and passes into the inverting device 34.

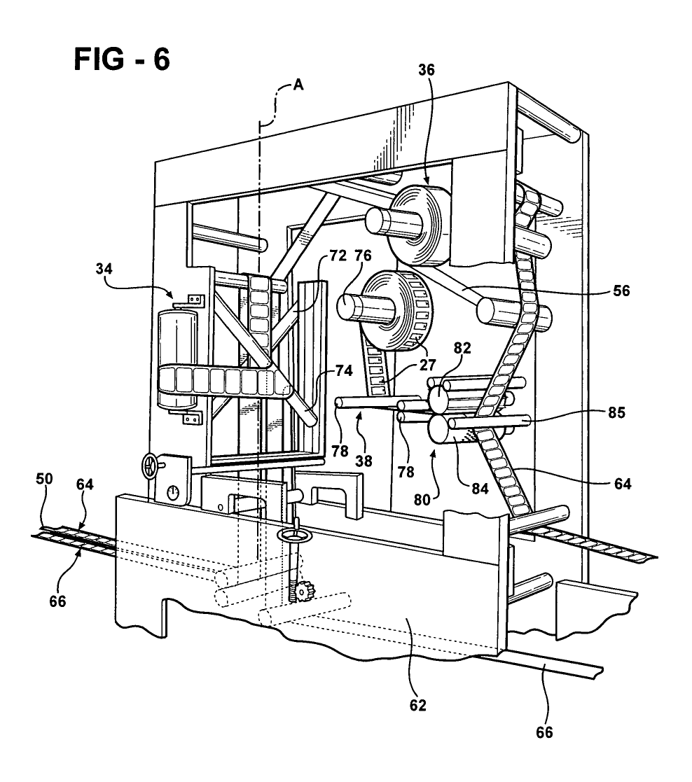

The inverting device 34 is shown schematically in FIG. 1 and more specifically in FIG. 6. The inverting device 34 rotates one of the first 64 and second 66 strips 180 degrees relative to the other first 64 and second strip 66. As one skilled in the art can appreciate, either of the strips 64, 66 may be inverted without deviating from the scope of the subject invention. Further, as discussed in greater detail below with respect to an alternative embodiment, an article 26 may be formed by the manufacturing machine assembly 25 having a RFID device 27 without passing through the inverting device 34.

The inverting device 34 includes a first turn bar 72 and a second turn bar 74 with a vertical axis A passing through an intersection of the first 72 and second 74 turn bars. Preferably, the first turn bar 72 is positioned at a 45 degree angle clockwise with respect to the vertical axis A and the second turn bar 74 is positioned at a 45 degree counterclockwise with respect to the vertical axis A. As discussed above, the second strip 66 preferably passes around the turn bars 72, 74 to be inverted 180 degrees. The preferred embodiment of the turn bars 72, 74 creates the least amount of stresses on the sheet of stock 50 as the second strip 66 passes around the turn bars 72, 74. As known to those skilled in the art, the first turn bar 72 could be positioned at any acute angle with respect to the vertical axis A, and the second turn bar 74 could be positioned at any acute angle with respect to the vertical axis A so long as the sum of the acute angles equals 90 degrees. The inverting device 34 may also include a number of additional bars and/or rollers for moving the second strip 66 of the card stock 50 through the inverting device 34. The inverting device 34 and its unique operation and related components form the claimed subject matter of U.S. Pat. No. 5,776,287, which is assigned to the assignee of the subject invention and is herein incorporated by reference.

The stripping device 36 is also located within Section B next to the inverting device 34. As best shown in FIGS. 1 and 6, the stripping device 36 removes the release liner 56 from the first strip 64 to expose the adhesive layer 54. The release liner 56 is then rolled onto a shaft (not numbered).

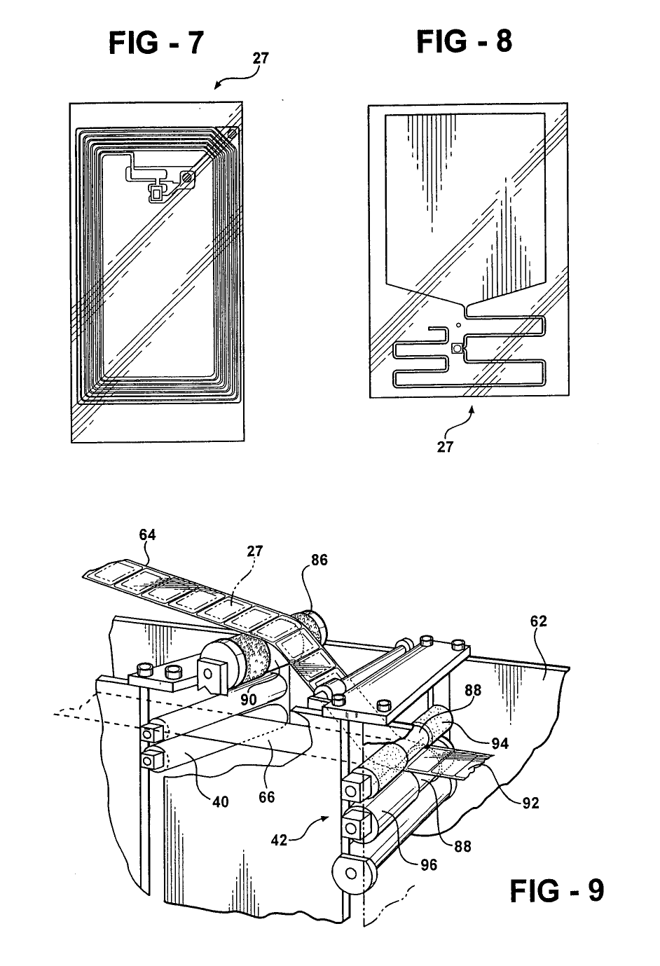

The applicator 38 is likewise mounted to the support frame 62 within Section B. As best shown in FIGS. 1 and 6, the applicator 38 applies a plurality of the RFID devices 27 to the exposed adhesive layer 54 of the first strip 64. Illustrative examples of the RFID devices 27 are shown in FIGS. 7 and 8. Preferably, the applicator 38 is mounted to the manufacturing machine assembly 25 immediately after and below the stripping device 36. As shown in FIGS. 1 and 6, the RFID devices 27 are initially attached to each other to form a continuous roll of RFID devices 27. The applicator 38 includes a shaft 76 for supporting the continuous roll of RFID devices 27. The applicator 38 also includes a series of feed rollers 78 that align the interconnected RFID devices 27 with a pair of application rollers 80. The application rollers 80 in turn include a cutting wheel 82 and an application wheel 84. The cutting wheel 82 includes a cutting surface disposed thereon for separating the interconnected RFID devices 27. The individual RFID devices 27 are then applied to the application wheel 84. The application wheel 84 may include a tacky surface disposed on an exterior thereof or may include a vacuum device for supporting and retaining the individual RFID devices 27 thereon. A guide wheel 85 is disposed adjacent the application wheel 84 for routing the first strip 64 of stock into the application wheel 84. The application wheel 84 can then apply an individual RFID device 27 onto the adhesive layer 54 of the first strip 64 in any predetermined spatial distance along a length of the first strip 64.

The applicator 38 illustrated is but one means for applying the RFID devices 27 to the adhesive layer 54 of the first strip 64. One skilled in the art will recognize that there are many methods of supporting, mounting and operating an RFID applicator 38. As such, the cutting and applying of the RFID devices 27 can be performed by any suitable device. Further, the RFID applicator 38 can equally apply the RFID device 27 onto an exposed adhesive layer 54 anywhere between any suitable stripping device and Section C of the manufacturing machine assembly 25. Further, it should be appreciated that the location and/or operation of the particular stripping device 36 shown may be modified to incorporate various designs of RFID applicators 38.

The first 64 and second 66 strips continue through Section B of the card manufacturing machine assembly 25 with the first strip 64 now including a series of RFID devices 27 adhered to the adhesive layer 54 and the second strip 66 is inverted 180 degrees such that the second strip 66 is now turned upside down relative to the first strip 64. Referring to FIGS. 1 and 9-11, the pair of coupling rollers 42 are rotatably mounted to the support frame 62 and the machine assembly 25 includes a non-stick roller 86 rotatably mounted to the support frame 62 between the applicator 38 and the coupling rollers 42. At least one of the coupling rollers 42 includes an integral notch 88 and the non-stick roller 86 similarly includes an integral notch 90. Preferably, each of the coupling rollers 42 includes an integral notch 88. The non-stick roller 86 includes a plurality of loose fibers adhered thereto such that the adhesive layer 54 of the first strip 64 does not adhere to the non-stick roller 86. In another alternative embodiment, the series of the RFID devices 27 could be applied to the exposed adhesive layer 54 of the first strip 64 after the first strip 64 passes over the non-stick roller 86.

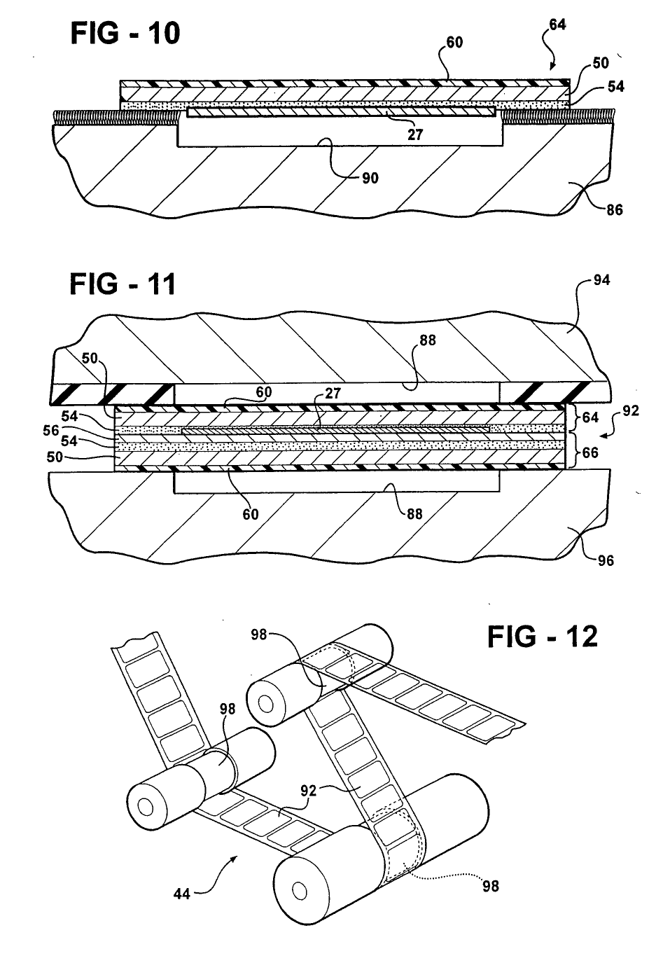

As best shown in FIGS. 9 and 10, the integral notch 90 on the non-stick roller 86 provides a passageway for the RFID devices 27 to ensure that the RFID devices 27 are not damaged when the exposed adhesive layer 54 of the first strip 64 passes over the non-stick roller 86. Similarly, as shown in FIGS. 9 and 11, the integral notch 90 of the coupling rollers 42 provide a passageway for the RFID devices 27 as the first 64 and second 66 strips pass between the coupling rollers 42. The coupling rollers 42 move the adhesive layer 54 of the first strip 64 into a bonded relationship with the second strip 66 to mate the first 64 and second 66 strips and form a continuous series of articles 92. The first strip 64 now defines the top surface 58 and the second strip 66 now defines the bottom surface 52 of the articles 26 and the plurality of RFID devices 27 are sandwiched between the first 64 and second 66 strips. Preferably, the notches 88 in the coupling rollers 42 provide a pair of passageways for the RFID devices 27 to ensure that the RFID devices 27 are not damaged during the bonding of the first 64 and second 66 strips. In the embodiment illustrated in FIGS. 1-14, the adhesive layer 54 of the first strip 64 is moved into a bonded relationship with the release liner 56 of the second strip 66 to form a card-like article 26, preferably a coupon card.

As shown in FIGS. 1 and 9, the scoring roller 40 is mounted on the support frame 62 between the inverting device 34 and the coupling rollers 42. The scoring roller 40 has a cutting surface thereon for only cutting through a portion of the second strip of stock 66 before the first 64 and second 66 strips of stock are bonded together. The scoring roller 40 is designed to form the perimeter of the mini-coupons printed on the surface of the second strip 66. In particular, the scoring cuts through the laminate 60, sheet of stock 50, and the adhesive layer 54 to form the removable mini-coupons.

After the first strip 64 passes over the non-stick roller 86 and the second strip 66 passes through the scoring roller 40, the first 64 and second 66 strips should be aligned both horizontally and longitudinally. In other words, the printed indicia on the first strip 64 should align with the printed indicia on the second strip 66. The coupling rollers 42 of the subject invention are specifically designed to maintain the desired alignment of the first 64 and second 66 strips. By maintaining exact alignments, each individual article 26 will be manufactured in accordance with desired specifications. For example, a two-sided coupon card will have perfectly aligned indicia on both sides thereof.

Preferably the coupling rollers 42 comprise a top roller 94 and a bottom roller 96. The top roller 94 has the resilient, substantially rubber-like exterior for gripping the first strip 64 and creating the continuous series of articles 92. The notch 88 in the top roller 94 is formed by removing a center section the rubber-like exterior. The bottom roller 96 is a metal cylinder having the notch 88 and a smooth exterior surface. As discussed above, once the strips 64, 66 have passed through the coupling rollers 42, the continuous sheet of stock 50 is transformed into the continuous series of articles 92 with each article 26 containing an embedded RFID device 27.

Referring to FIGS. 1 and 12-13, the continuous series of articles 92 now moves into Section C of the manufacturing machine assembly 25, which is the exit station. The series of articles 92 passes through at least one tensioning roller 44 which is rotatably mounted to the support frame 62 between the coupling rollers 42 and the exit rollers 46. Preferably there are a series of tensioning rollers 44 with at least one of the tensioning rollers 44 including an integral notch 98. As with the notches 88, 90 of the non-stick roller 86 and coupling rollers 42, the integral notch 98 of the tensioning roller 44 provides yet another passageway for the RFID devices 27 to ensure that the RFID devices 27 are not damaged when the continuous series of articles 92 passes over the tensioning rollers 44. The tensioning rollers 44 and integral notches 98 are best shown in FIG. 12.

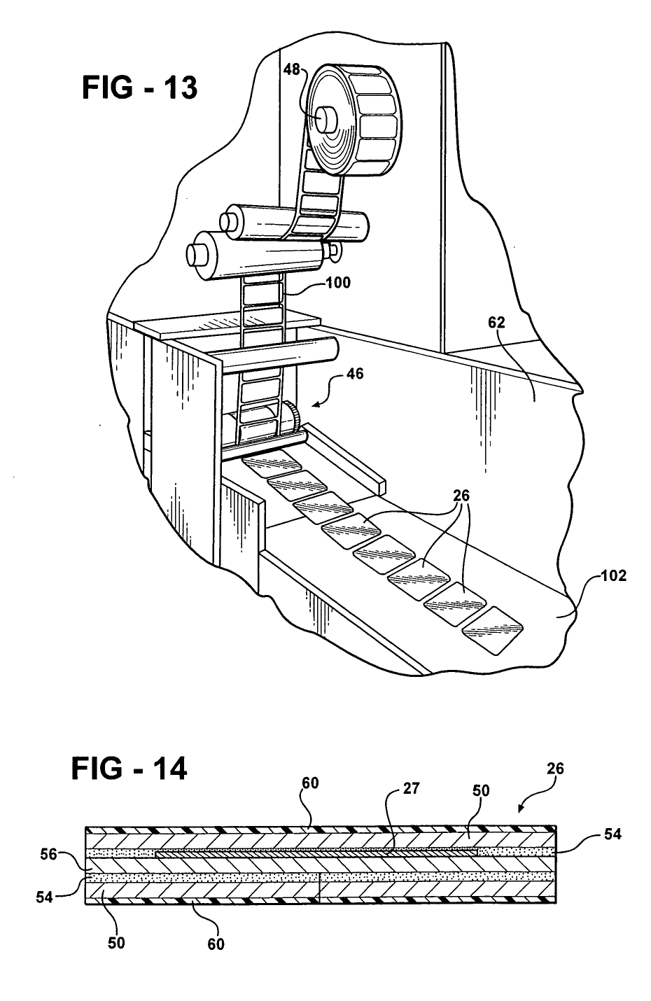

The continuous series of articles 92 now continues through Section C to the pair of exit rollers 46. The exit rollers 46 are mounted on the support frame 62 with at least one of the exit rollers 46 having a cutting surface thereon. The cutting surface completely cuts through the first 64 and second 66 strips for forming and separating the continuous series of articles 92 from the continuous sheet of stock 50. In particular, the exit rollers 46 engage the continuous sheet of stock 50 to remove an exterior material which forms and separates the continuous series of articles 92 and creates a web of scrap exterior material 100. In one embodiment, the exit rollers 46 also include a secondary scoring surface for completely cutting through the first 64 and second 66 strips between the articles 26 of the continuous series of articles 92 to separate each article 26 from each other. As illustrated in FIG. 13, the exit roller 46 can punch out the individual articles 26, such as the individual cards or coupon cards, from the continuous series of articles 92. The cards subsequently accumulate along an exit chute 102 with each article 26 having a RFID device 27 embedded therein. As another alternative, the continuous series of articles 92 could remain interconnected and could be folded upon themselves, which is known in the art as fan folding. Of course, it should be appreciated that the manner in which the products are discharged could be of any suitable design without deviating from the overall scope of the subject invention.

FIG. 14 illustrates a cross-sectional view of the individual articles 26 after the articles 26 have exited the manufacturing machine assembly 25. The laminate 60 of the first strip 64 is now the top surface 58 of the article 26, and the laminate 60 of the second strip 66 is now the bottom surface 52 of the article 26. Preferably in this example, the article 26 is a coupon card. Hence, the first strip 64 defines the top surface 58 and the second strip 66 defines the bottom surface 52 of the two-sided coupon cards. In other words, the top surface 58 of the cards includes the marketing information printed thereon and the bottom surface 52 of the coupon cards includes the mini-coupons. The continuous sheet of stock 50 having the two strips 64, 66 as shown in FIG. 3, is now converted into the continuous series of articles 92, having two layers of card stock as shown in FIG. 14.

The method of manufacturing the article 26 having the RFID device 27 will now be discussed in further detail. The method first comprises a step of printing the indicia on the top surface 58 of the continuous sheet of stock 50 to define the first strip 64 and the second strip 66 of the stock. The clear laminate 60 can then be applied to the top surface 58 of the continuous stock 50 for protecting and viewing the indicia. As mentioned above, the step of applying the clear laminate 60 could be eliminated without deviating from the scope of the subject invention.

The continuous sheet of stock 50 can be cut to separate the first 64 and second 66 strips of stock. In the embodiment of FIGS. 1 through 14, the step of printing the indicia is further defined as printing the indicia in two parallel rows at the same time to define the first 64 and second 66 strips. As mentioned above, the dual printing in the parallel rows is typically performed when creating a two-sided label or card, such as a coupon card.

After the strips 64, 66 are cut, one of the first 64 and second 66 strips are rotated 180 degrees relative to the other first 64 and second 66 strip. The release liner 56 is then removed from the first strip 64 to expose the adhesive layer 54 of the first strip 64. The plurality of the RFID devices 27 are applied to the exposed adhesive layer 54 of the first strip 64.

A section of the second strip of stock 66 can be cut to form the plurality of removal mini-coupons. As mentioned above, this step is, of course, accomplished when the article 26 is to be defined as a coupon card.

The first 64 and second 66 strips are then aligned with the coupling rollers 42. The RFID devices 27 are also aligned with the notch 88 in the coupling roller 42. As mentioned above, there is preferably one notch 88 in each of the coupling rollers 42 such that the RFID devices 27 are aligned with both of the notches 88 in the coupling rollers 42. The adhesive layer 54 of the first strip 64 is then mated with the second strip 66 to bond the first 64 and second 66 strips together to form the continuous series of articles 92. In the embodiment where the article 26 is defined as the card, the step of mating the adhesive layer 54 of the first strip 64 with the second strip 66 is further defined as moving the adhesive layer 54 of the first strip 64 into a bonded relationship with the release liner 56 of the second strip 66. This structure allows the pre-cut mini-coupons to be removed from the remaining portions of the card. In either case, once the strips 64, 66 have been bonded together, the first strip 64 defines the top surface 58 and the second strip 66 defines the bottom surface 52 of the articles 26. During the bonding of the first 64 and second 66 strips, the RFID devices 27 simultaneously pass through the notches 88 to ensure that the RFID devices 27 are not damaged. The RFID devices 27 are also simultaneously sandwiched between the first 64 and second 66 strips.

The first 64 and second 66 strips now move into the exit rollers 46 and are completely cut for forming and separating the continuous series of articles 92 from the continuous sheet of stock 50. In the embodiment of forming the card, the first 64 and second 66 strips are completely cut between the articles 26 of the continuous series of articles 92 to separate each article 26, i.e., card, from each other. The cutting of the first 64 and second 66 strips to form the continuous series of articles 92 also creates a continuous web of scrap stock 100. The continuous web of scrap stock 100 is then collected upon the take-up roller 48.

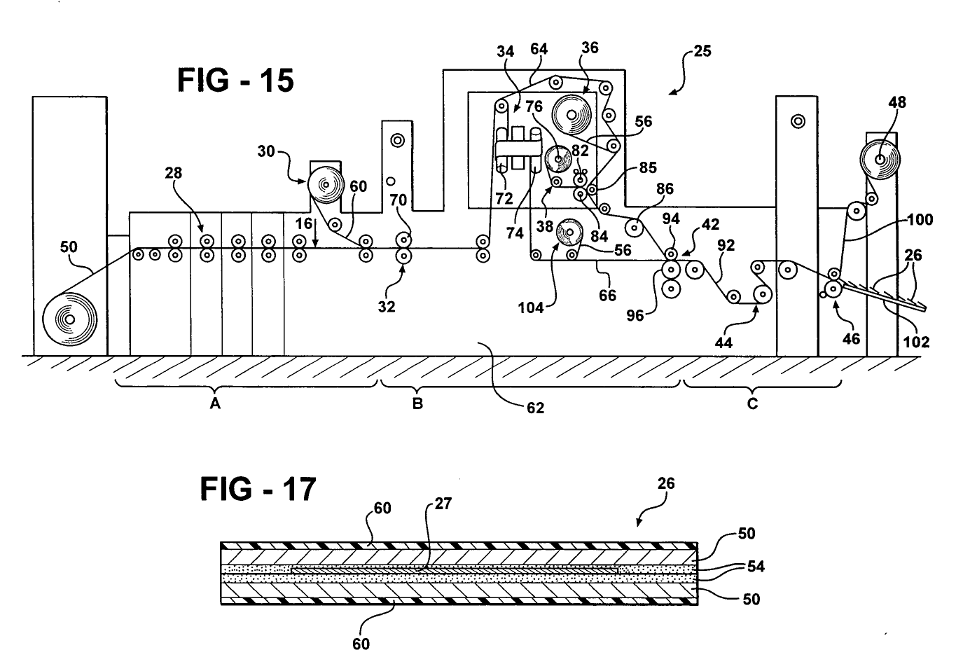

Turning to FIGS. 15-17, an alternative method of manufacturing the article 26 having the RFID device 27 is now disclosed. Many features of this alternative embodiment are similar to the embodiments of FIGS. 1-14. In particular, the article 26 is fabricated from a similar continuous sheet of stock 50 having a similar adhesive layer 54 and similar release liner 56. The method also includes similar steps of printing indicia on the top surface 58 of the continuous sheet of stock 50, cutting the continuous sheet of stock 50, inverting one of the first 64 and second 66 strips, removing the release liner 56 from the first strip 64, and applying in a plurality of the RFID devices 27.

The primary difference between the article 26 being manufactured in this alternative method and the article 26 manufactured in accordance with FIGS. 1-14, relates to the type of article 26 being made. As mentioned above, one preferred embodiment of the article 26 in FIGS. 1-14 is a coupon card. The coupon card of FIGS. 1-14 requires that the bottom portion of the card include the release liner 56 such that the coupon cards may be removed from the remaining portion of the card. The article 26, i.e., the card, of this alternative method does not include the release liner 56. In other words, the method includes the additional step of removing the release liner 56 from the second strip 66 to expose the adhesive layer 54 of the second strip 66. Hence, the mating of the first 64 and second 66 strips is further defined as mating the adhesive layer 54 of the first strip 64 with the adhesive layer 54 of the second strip 66 to bond the first 64 and second 66 strips together to form the continuous series of articles 92. Similarly, the first strip 64 defines the top surface 58 and the second strip 66 defines the bottom surface 52. However, alternatively, the plurality of RFID devices 27 are now sandwiched between the adhesive layers 54 of the first 64 and second 66 strips. This method and embodiment of article 26 ensures that the RFID device 27 is adequately secured within the article 26 itself.

As shown in FIG. 15, a second stripping device 104 is mounted to the support frame 62 between the inverting device 34 and the coupling roller 42 for removing the release liner 56 from the second strip 66 to expose the adhesive layer 54 of the second strip 66. The second stripping device 104 may be of a similar apparatus as the first stripping device 36. It should be appreciated that the second stripping device 104 may be mounted on the support frame 62 in any suitable position.

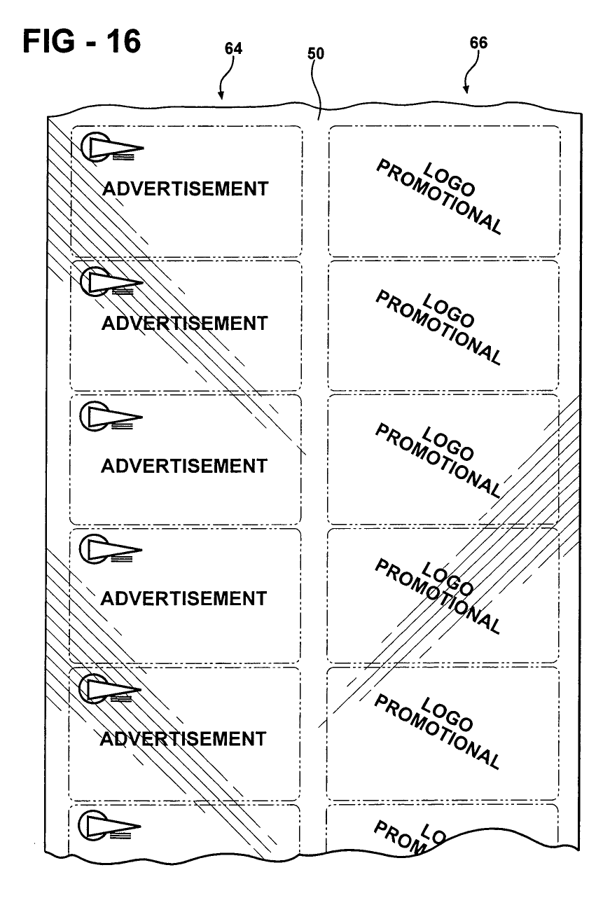

As shown in FIG. 16, the indicia printed on the top surface 58 of the continuous sheet of stock 50 is printed in two parallel rows at the same time to define the first 64 and second 66 strips. The printed indicia in this embodiment, however, does not include the mini-coupons. As discussed above, the article 26 formed by this method will not include a release liner 56 such that the coupons cannot be subsequently removed. As such, the printed indicia on the top surface 58 will typically include advertisements, marketing information and/or a single promotional coupon. The alternative method may also include the step of applying clear laminate 60 to the top surface 58 for protecting and viewing the indicia.

As with the embodiment of FIGS. 1-14, the first 64 and second 66 strips are completely cut by the exit rollers 46 for forming and separating the continuous series of articles 92 from the continuous sheet of stock 50. Further, the first 64 and second 66 strips may be completely cut between the articles 26 of the continuous series of articles 92 to separate each article 26, i.e., each card, from each other. A cross-sectional view of one of the articles 26 formed by this alternative method is shown in FIG. 17. As is clearly illustrated in FIG. 17, the adhesive layers 54 of the first 64 and second 66 strips now encapsulates the RFID device 27.

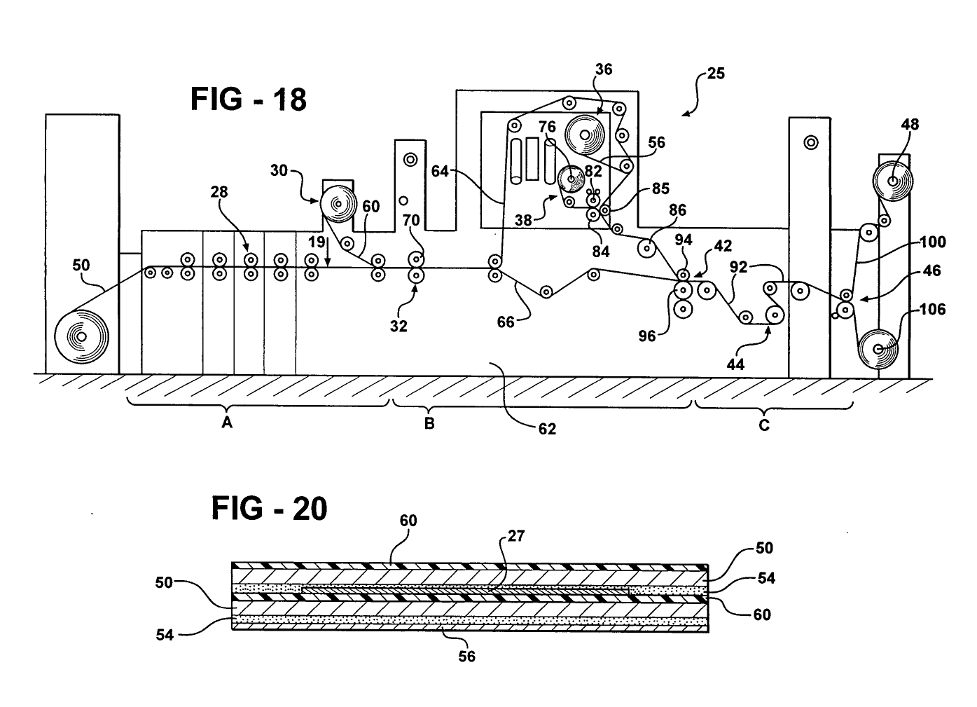

Turning now to FIGS. 18-20, yet another alternative embodiment of the manufacturing machine assembly 25 is shown. This alternative method of manufacturing the article 26 having the RFID device 27 is similar to the previous embodiments discussed above. In particular, this method of manufacturing similarly includes the steps of printing the indicia, cutting the continuous sheet of stock 50, removing the release liner 56 from the first strip 64, applying a plurality of the RFID devices 27 to the first strip 64, and applying a clear laminate 60 to the top surface 58. This embodiment, however, illustrates two primary alternatives for the method of manufacturing.

One alternative relates to bypassing the inverting device 34. In particular, the second strip of stock 66 separates from the first strip 64 and passes underneath the first strip 64 as the release liner 56 is removed and the RFID device 27 is applied to the first strip 64. The second strip 66 passes downwardly away from the first strip 64 and by-passes the inverting device 34. Alternatively, the inverting device 34 may be removed altogether. The second strip 66 therefore runs along the longitudinal path of the manufacturing machine assembly 25. The adhesive layer 54 of the first strip 64 is then bonded directly to the second strip 66. In particular, if the clear laminate 60 is applied to the first 64 and second 66 strips, then the adhesive layer 54, along with the RFID device 27 of the first strip 64, is bonded to the clear laminate 60 of the second strip 66. Alternatively, if the clear laminate 60 is not applied to the first 64 and second 66 strips, then the adhesive layer 54, along with the RFID device 27 of the first strip 64, is bonded directly to the stock 50 of the second strip 66. Hence, the coupling rollers 42 move the adhesive layer 54 of the first strip 64, with the RFID device 27, into a bonded relationship with a top surface of the second strip to stock 66 to mate the first 64 and second 66 strips and form the continuous series of articles 92. The article 26 constructed in this manner is typically used as a label.

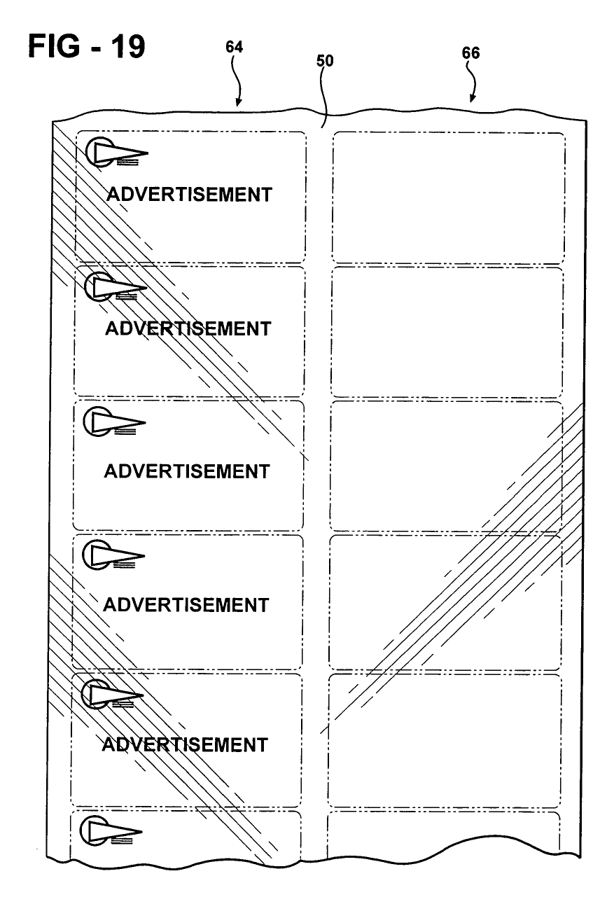

As shown in FIG. 19, the indicia is printed in only one row to define the first 64 and second 66 strips. Since the first strip 64 will be applied over the second strip 66 it is not necessary to print indicia on the second strip 66 as this second strip 66 will be hidden by the first strip 64. The cross-sectional view of the article 26 is illustrated in FIG. 20. The article 26 shown in FIG. 20 discloses the embodiment where the clear laminate 60 is applied. As clearly illustrated, the liner 56 of the second strip 66 now defines the bottom surface of the article 26. As appreciated, the liner 56 can be subsequently removed such that the article 26 will have an exposed adhesive. This exposed adhesive allows the article 26 to be applied to any suitable surface such as a container, product, vehicle, etc. It should be appreciated that the Applicant has contemplated an embodiment where the laminate 60 is not applied to the first 64 and second 66 strips such that the cross-sectional view of FIG. 20 would be substantially similar with the clear laminate 60 layers being absent.

The second alternative illustrated in FIG. 18 relates to the exit station of Section C. In particular, the embodiment of FIG. 18 contemplates the alternative of the exit rollers 46 cutting through the first 64 and second 66 strips for forming and separating the continuous series of articles 92 from the continuous sheet of stock 50. A discharge roller 106 is mounted to the support frame 62 and collects the continuous series of articles 92 exiting from the exit rollers 46. Hence, the continuous series of articles 92 remains interconnected and this alternative method includes the step of collecting the continuous series of articles 92 in a roll on the discharge roller 106. This alternative method of collection, as opposed to completely punching out the articles 26 from the continuous series of articles 92, could be applied to any of the above-described methods. In other words, the exit rollers 46 shown in FIGS. 1 and 15 can be modified to maintain the continuous series of articles 92 and a discharge roller 106 could be installed onto these manufacturing machine assemblies to collect the continuous series of articles 92.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims the invention may be practiced otherwise than as specifically described.

1. A manufacturing machine assembly for producing an article having a radio frequency identification (RFID) device with the article fabricated from a continuous sheet of stock having a top surface and a bottom surface with an adhesive layer and release liner, said assembly comprising:
a support frame for supporting the continuous sheet of stock as the sheet of stock moves through said machine assembly;
a printing station for printing indicia on the top surface of the continuous sheet of stock that define a first strip and a second strip of the stock;
a cutting station mounted to said support frame for cutting the continuous sheet of stock to separate the first and second strips;
a stripping device mounted to said support frame for removing the release liner from the first strip to expose the adhesive layer;
an applicator mounted to said support frame for applying a plurality of the RFID devices to the exposed adhesive layer of the first strip; and
a pair of coupling rollers rotatably mounted to said support frame for moving the adhesive layer of the first strip into a bonded relationship with the second strip to mate the first and second strips and form a continuous series of articles wherein the first strip defines the top surface and the second strip defines the bottom surface of the articles and the plurality of RFID devices are sandwiched between the first and second strips;
at least one of said coupling rollers including an integral notch for providing a passageway for the RFID devices as the first and second strips pass between said coupling rollers, thereby ensuring that the RFID devices are not damaged during the bonding of the first and second strips.

2. An assembly as set forth in claim 1 wherein each of said coupling rollers includes an integral notch for providing a passageway for the RFID devices.

3. An assembly as set forth in claim 1 further including a non-stick roller rotatably mounted to said support frame between said applicator and said coupling rollers with said non-stick roller including an integral notch for providing an additional passageway for the RFID devices to ensure that the RFID devices are not damaged when the exposed adhesive layer of the first strip passes over said non-stick roller.

4. An assembly as set forth in claim 1 further including a laminating device mounted to said support frame for applying a clear laminate to the top surface of the continuous sheet of stock for protecting and viewing the indicia.

5. An assembly as set forth in claim 1 further including a pair of exit rollers mounted on said support frame with at least one of said exit rollers having a cutting surface thereon for completely cutting through the first and second strips for forming and separating the continuous series of articles from the continuous sheet of stock.

6. An assembly as set forth in claim 5 further including at least one tensioning roller rotatably mounted to said support frame between said coupling rollers and said exit rollers with said tensioning roller including an integral notch for providing another passageway for the RFID devices to ensure that the RFID devices are not damaged when the continuous series of articles passes over said tensioning roller.

7. An assembly as set forth in claim 5 further including a discharge roller mounted to said support frame for collecting the continuous series of articles exiting said exit rollers.

8. An assembly as set forth in claim 1 further including an inverting device mounted on said support frame for rotating one of the first and second strips 180 degrees relative to the other first and second strip.

9. An assembly as set forth in claim 8 further including a scoring roller mounted on said support frame between said inverting device and said coupling rollers with said scoring roller having a cutting surface thereon for only cutting through a portion of the second strip of stock before the first and second strips of stock are bonded together.

10. An assembly as set forth in claim 8 further including a second stripping device mounted on said support frame between said inverting device and said coupling roller for removing the release liner from the second strip to expose the adhesive layer of the second strip.

11. An assembly as set forth in claim 10 further including a pair of exit rollers mounted on said support frame with at least one of said exit rollers having a cutting surface thereon for completely cutting through said first and second strips for forming and separating the continuous series of articles from the continuous sheet of stock and for completely cutting through the first and second strips between the articles of the continuous series of articles to separate each article from each other.

12. A method of manufacturing an article having a radio frequency identification (RFID) device using a machine assembly having a pair of coupling rollers with at least one of the rollers including an integral notch, the article being fabricated from a continuous sheet of stock having a top surface and a bottom surface with an adhesive layer and release liner, said method comprising the steps of:
printing indicia on the top surface of the continuous sheet of stock to define a first strip and a second strip of the stock;
cutting the continuous sheet of stock to separate the first and second strips of stock;
removing the release liner from the first strip to expose the adhesive layer;
applying a plurality of the RFID devices to the exposed adhesive layer of the first strip;
aligning the first and second strips with the coupling rollers;
aligning the RFID devices with the notch in the coupling roller;
mating the adhesive layer of the first strip with the second strip to bond the first and second strips together and form a continuous series of articles wherein the first strip defines the top surface and the second strip defines the bottom surface of the articles, and simultaneously passing the RFID devices through the notch to ensure that the RFID devices are not damaged as the plurality of RFID devices are sandwiched between the first and second strips.

13. A method as set forth in claim 12 further including the step of cutting completely through the first and second strips for forming and separating the continuous series of articles from the continuous sheet of stock.

14. A method as set forth in claim 13 further including the step of cutting completely through the first and second strips between the articles of the continuous series of articles to separate each article from each other.

15. A method as set forth in claim 13 further including the step of collecting the continuous series of articles in a roll.

16. A method as set forth in claim 12 wherein the step of printing indicia is further defined as printing indicia in two parallel rows at the same time to define the first and second strips.

17. A method as set forth in claim 12 wherein the step of printing indicia is further defined as printing indicia in only one row to define the first and second strips.

18. A method as set forth in claim 12 further including the step of rotating one of the first and second strips 180 degrees relative to the other first and second strip before the step of mating the strips.

19. A method as set forth in claim 18 wherein the step of mating the adhesive layer of the first strip with the second strip is further defined as moving the adhesive layer of the first strip into a bonded relationship with the release liner of the second strip.

20. A method as set forth in claim 19 further including the step of cutting through a section of the second strip of stock to form a plurality of removable mini-coupons.

21. A method as set forth in claim 18 further including the step of removing the release liner from the second strip to expose the adhesive layer of the second strip.

22. A method as set forth in claim 21 wherein the step of mating the adhesive layer of the first strip with the second strip is further defined as moving the adhesive layer of the first strip into a bonded relationship with the adhesive layer of the second strip thereby sandwiching the RFID device between the adhesive layers of the first and second strips.

23. A method as set forth in claim 12 further including the step of applying a clear laminate to the top surface of the continuous sheet of stock for protecting and viewing the indicia.

24. A method of manufacturing an article having a radio frequency identification (RFID) device with the article being fabricated from a continuous sheet of stock having a top surface and a bottom surface with an adhesive layer and release liner, said method comprising the steps of:
printing indicia on the top surface of the continuous sheet of stock to define a first strip and a second strip of the stock;
cutting the continuous sheet of stock to separate the first and second strips of stock;
inverting one of the first and second strips 180 degrees relative to the other first and second strip;
removing the release liner from the first strip to expose the adhesive layer of the first strip;
applying a plurality of the RFID devices to the exposed adhesive layer of the first strip;
removing the release liner from the second strip to expose the adhesive layer of the second strip;
mating the adhesive layer of the first strip with the adhesive layer of the second strip to bond the first and second strips together and form a continuous series of articles wherein the first strip defines the top surface and the second strip defines the bottom surface of the articles and the plurality of RFID devices are sandwiched between the adhesive layers of the first and second strips.

25. A method as set forth in claim 24 further including the step of cutting completely through the first and second strips for forming and separating the continuous series of articles from the continuous sheet of stock.

26. A method as set forth in claim 25 further including the step of cutting completely through the first and second strips between the articles of the continuous series of articles to separate each article from each other.

27. A method as set forth in claim 25 further including the step of collecting the continuous series of articles in a roll.

28. A method as set forth in claim 24 wherein the step of printing indicia is further defined as printing indicia in two parallel rows at the same time to define the first and second strips.

29. A method as set forth in claim 24 further including the step of applying a clear laminate to the top surface of the continuous sheet of stock for protecting and viewing the indicia.
